(19) United States
(12) Patent Application Publication
(10) Pub. No.: US 2006/0039348 A1
(43) Pub. Date: Feb. 23, 2006

(54) System, device and method for data transfer

(75) Inventors: Ferenc Dosa Racz, Helsinki (FI); Johan Wikman, Helsinki (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/922,421

(22) Filed: Aug. 20, 2004

(51) Int. Cl. H04L 12/28; H04L 12/56

(52) U.S. Cl. 370/351; 370/389

(57) ABSTRACT

A device, system and method for data transfer. Embodiments of the present invention may include receiving a Bluetooth Device Address; receiving an identifier token corresponding to the Bluetooth Device Address; and initiating a data transfer using the identifier token. The identifier token may be an IP address. The data transfer may be an IP-based data transfer. The data transfer may also be a wireless data transfer or a wired data transfer. The data transfer may also be a peer-to-peer data transfer. The method may further comprise initiating a Bluetooth inquiry.

### FIELD OF THE INVENTION

The present invention relates to the field of data transfer and, in particular, to the field of device searching and data transfer to a device that has been found in response to a search.

### BACKGROUND

Data transfer between two or more devices, such as mobile telephones, for example, has traditionally been accomplished by the least expensive means available. Thus, many free data communication techniques, such as IrDA and Bluetooth, for example, have been used to transfer data inexpensively.

However, many available technologies have technical characteristics that limit their usefulness in data transmission. For example, many Bluetooth implementations do not perform adequately in contexts demanding flexible connectivity. While a Bluetooth device may be able to perform an inquiry, a Bluetooth device generally cannot receive or respond to an inquiry from another Bluetooth device and generally cannot perform data transfer while simultaneously making an inquiry. Thus, data transfer using Bluetooth typically requires a tradeoff between data transfer throughput and device visibility, flexibility and connectivity.

Other technologies have practical limitations as well. For example, data transfer between devices may be accomplished via IP-based networking. While IP-based networking generally scales well with respect to connectivity, it is generally not possible for an IP-based device to query the IP addresses of other devices that are in proximity to the IP-based device. Thus, data transfer using IP-based networking also requires a tradeoff between data transfer throughput and device visibility.

### SUMMARY

According to an embodiment of the present invention, a method for data transfer may include performing a Bluetooth inquiry; receiving an identifier token corresponding to a Bluetooth Device Address in response to the inquiry; and initiating a data transfer using the identifier token. The identifier token may be an IP address or a URL. The data transfer may be an IP-based data transfer. The data transfer may also be a wireless data transfer or a wired data transfer. The data transfer may also be a peer-to-peer data transfer. The method may further comprise initiating a Bluetooth inquiry.

According to an embodiment of the present invention, a device for transferring data may include a storage unit for storing data; and a processor communicatively coupled to the storage unit. The processor may be configured to: perform a Bluetooth inquiry; receive an identifier token corresponding to a Bluetooth Device Address in response to the inquiry; and initiate a data transfer using the identifier token. The identifier token may be an IP address or a URL. The data transfer may be an IP-based data transfer. The data transfer may also be a wireless data transfer or a wired data transfer. The data transfer may also be a peer-to-peer data transfer. The processor may be further configured to initiate a Bluetooth inquiry.

According to an embodiment of the present invention, a system for data transfer may include a client device for initiating a Bluetooth inquiry; a first server for providing networking services, the first server configured to map a Bluetooth Device Address to an identifier token; and a second server communicatively coupled to the client device and the first server, the second server configured to respond to a Bluetooth inquiry. The client device may be configured to search for other devices using Bluetooth and to transfer data to using a networking protocol.

Embodiments of the present invention may include a computer program product having a computer useable medium that includes computer program logic recorded thereon for enabling a processor to transfer data may include, where the computer program logic may include a performing procedure enabling the processor to perform a Bluetooth inquiry; a receiving procedure enabling the processor to receive an identifier token corresponding to a Bluetooth Device Address in response to the inquiry; and an initiating procedure enabling the processor to initiate a data transfer using the identifier token.

According to an embodiment of the present invention, a method for data transfer may include receiving an identifier token from a first device; receiving a Bluetooth Device Address for the first device; mapping the Bluetooth Device Address to the identifier token; and transferring the identifier token to a second device subsequent to a Bluetooth inquiry by the second device.

According to an embodiment of the present invention, a device for transferring data may include a storage unit for storing data; and a processor communicatively coupled to the storage unit, the processor configured to receive an identifier token from a first device; receive a Bluetooth Device Address for the first device; map the Bluetooth Device Address to the identifier token; and transfer the identifier token to a second device subsequent to a Bluetooth inquiry by the second device.

### BRIEF DESCRIPTION OF THE DRAWINGS

A detailed description of embodiments of the invention will be made with reference to the accompanying drawings, wherein like numerals designate corresponding parts in the several figures.

FIG. 1 shows a generalized system for data transfer according to an embodiment of the present invention.

FIG. 2 shows a generalized method for data transfer according to an embodiment of the present invention.

FIG. 3 shows a generalized method of system data transfer according to an embodiment of the present invention.

FIG. 4 shows a generalized block diagram for a mapper service according to an embodiment of the present invention.

FIG. 5 shows a generalized block diagram for a webserver and mapper service according to an embodiment of the present invention.

FIG. 6 shows a generalized block diagram for a webserver and mapper service according to an embodiment of the present invention.

FIG. 7 shows a generalized block diagram for a webserver and mapper service according to an embodiment of the present invention.

FIG. 8 shows a generalized block diagram for a reverse proxy and mapper service according to an embodiment of the present invention.

### DETAILED DESCRIPTION OF EXEMPLARY EMBODIMENTS

In the following description of preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the preferred embodiments of the present invention.

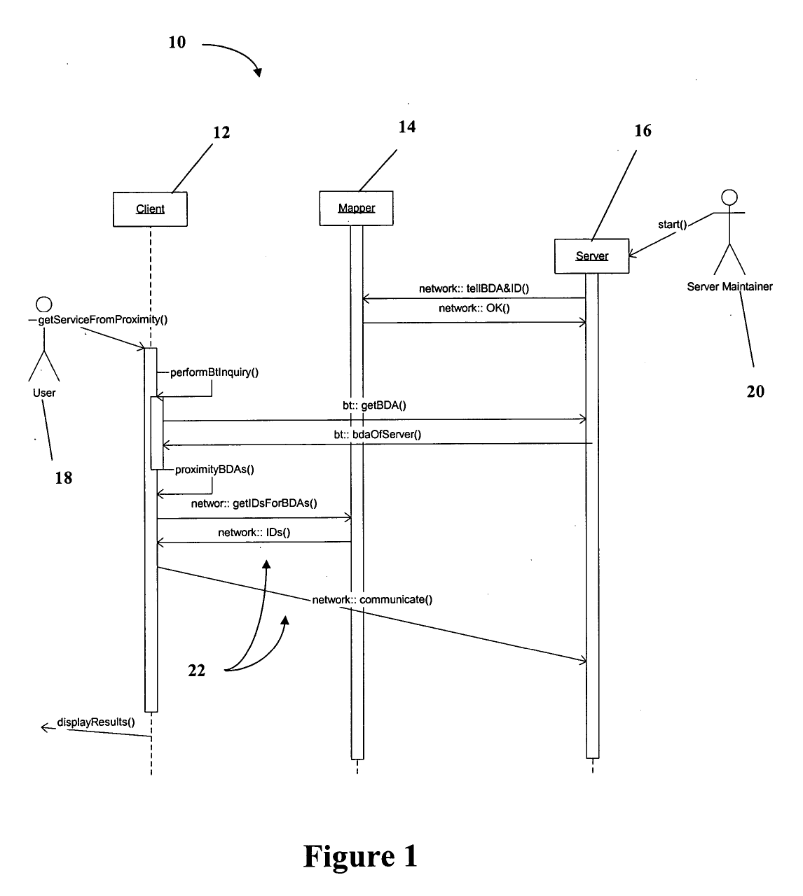

FIG. 1 shows a generalized system for data transfer 10 according to an embodiment of the present invention. The system for data transfer 10 of FIG. 1 includes, without limitation, a client device 12, a mapper 14, and a server 16. The client device 12, the mapper 14 and the server 16 may communicate with each other over a network 22, such as the Internet for example.

The client device 12 may be any of a variety of electronic devices. For example, the client device 12 may a mobile telephone, a PDA, a laptop computer and the like. The client device 12 may communicate via a wired or wireless connection. For example, the client device 12 may communicate over a network such as a cellular network.

The client device 12 may also be equipped with a Bluetooth adapter and, thus, may be capable of performing Bluetooth inquires. According to the embodiment of the invention shown in FIG. 1, the client device 12 may wish to perform an IP-based communication, such as a data communication, for example, over a cellular network to any server that may be found in its proximity.

According to the embodiment of the invention shown in FIG. 1, the mapper 14 may be a stationary server on the Internet, which is known both to the client 12 and the server 16. The mapper 14 may include, without limitation, one or more processors, memory, permanent storage, input/output and one or more communication interfaces. The mapper 14 may be used to keep track of all servers, as well as the Bluetooth Device Addresses (BDAs) and identifier tokens, such as IP addresses, for example, of all such servers, that are online and available over the network. The mapper may provide the BDAs and identifier tokens of the available servers, as well as other information, to any client device on the network that may be interested in such information.

According to the embodiment of the invention shown in FIG. 1, the server 16 may include, without limitation, one or more processors, memory, permanent storage, input/output and one or more communication interfaces. The server 16 may provide wired or wireless Internet service and may be equipped with a Bluetooth adapter. Thus, the server 16 may be capable of responding to Bluetooth inquires.

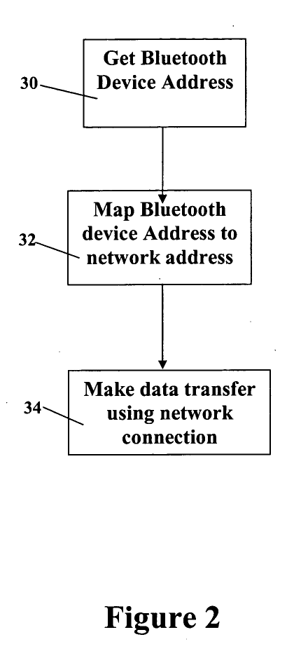

FIG. 2 shows a generalized method for data transfer according to an embodiment of the present invention. At step 30, a BDA of a device is obtained. The BDA of a device may be desired by another local peer device. For example, a mobile device may be interested in communicating in a wireless, peer-to-peer fashion with another mobile device in close proximity and, consequently, may desire the BDA of the other mobile device. Thus, a mobile device may find another mobile device using the proximity-awareness capabilities of Bluetooth.

At step 32, the BDA of the device is mapped to the network address of the device, such as an IP address, for example. For example, if a first mobile device has obtained the BDA of a second mobile device in proximity to the first mobile device, the BDA of the second mobile device may be mapped to the IP address of the second mobile device. The IP address of the second mobile device may be made available to the first mobile device. It should be noted that the mapping of the BDA to an IP address is only an example mapping and constitutes only one embodiment of the present invention. The BDA may the mapped to any identifier token that enables the first mobile device to reach the second mobile device or that enables any device to reach a target device.

At step 34, a data transfer is made using the network address, such as the IP address, for example. The data transfer may be initiated by the first mobile device, for example, using an IP-based communication methodology. The first mobile device may make a peer-to-peer data transfer to the second mobile device. The data transfer may be a wireless data transfer.

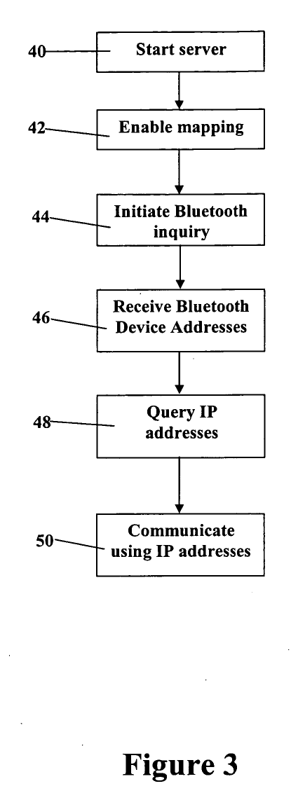

FIG. 3 shows a generalized method of system data transfer according to an embodiment of the present invention. Referring to FIG. 3 and FIG. 1, at step 40, a server is started. A server 16 may be started by a server maintainer 20. Upon initialization of the server 16, the server 16 connects to the mapper 14 and tells the mapper 14 the BDA and IP address of the server 16. The server 16 may communicate with the mapper 14 using an IP-based protocol. The mapper 14 may store this information. When the server 16 shuts down, the server 16 may connect to the mapper 14 to inform the mapper 14 that the server 16 is no longer available.

At step 42, mapping is enabled. The mapper 14 may tell the server 16 that a mapping from the server 16 BDA to the server 16 IP address is now public.

When a user 18 is interested in using a service within his proximity, the user 18 may initiate an action on an application at the client device 12 via a user interface. At step 44, the user 18 may initiate a Bluetooth inquiry. As a result of the Bluetooth inquiry, the user 18 may receive at the client device 12 the BDA of Bluetooth devices in his proximity at step 46.

Once the user 18 and the client device 12 have the BDAs of devices in proximity, the IP addresses of these devices is determined. The client device 12 may connect to the mapper 14 and queries the IP addresses of the BDAs at step 48. The client device 12 may connect to the mapper 14 using an IP-based protocol.

The mapper 14 returns IP addresses to the client device 12 for each BDA in proximity having an IP address. With the IP addresses available, the client device 12 may communicate with the devices having these IP addresses at step 50. Results may be displayed to the user 18.

Any number of modifications to the embodiments of the invention discussed above may be made. For example, according to embodiments of the present invention, the mapper 14 could be configured to return more information then an IP address. For example, the mapper 14 may identify the services provided by the server 16, on which port such services exist, other augmenting information, such as displaying a picture or an advertisement to the user 18 when selecting between services, and the like.

According to other embodiments of the present invention, the mapper 14 may include additional functionality. Under some schemes, a connection to a server 16 may be complicated. Connection details may be hidden from the client 12 and may be a matter between the server 16 and the mapper 14. Thus, the mapper 14 may function as a proxy/gateway between the client 12 and the server 16. In other words, data communication may be effected via the mapper 14. Thus, clients 12 would not be unnecessarily burdened by with actual IP addresses. Under this scheme, the client 12 may receive some other identifier token and may connect to the mapper 14. The mapper 14 in turn would relay the communication further to the server 16. For example, according to an embodiment of the present invention, the mapper 14 may function as an http gateway between a client 12 implemented as an html browser and a server 16 functioning as a webserver behind a firewall.

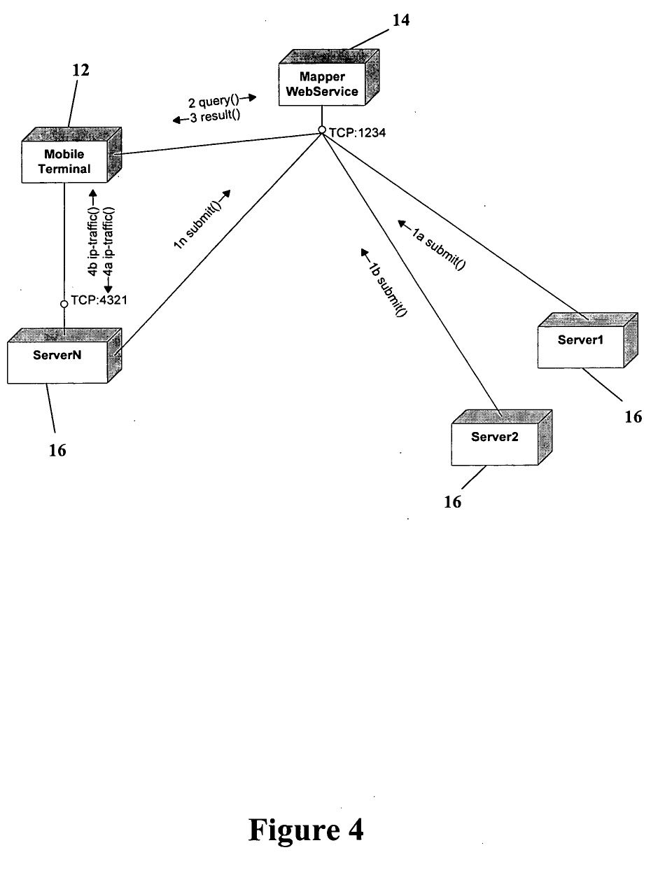

Embodiments of the present invention may be used in a variety of contexts and applications. For example, FIG. 4 shows a generalized block diagram for data transfer according to an embodiment of the present invention. In FIG. 4, one or more servers 16 (mobile or stationary) may submit data of various types to a mapper 14. The data may be shared only once, such as at startup, for example, or may be shared regularly. Such data may include, without limitation, a BDA, a server 16 url or IP address, a server 16 domain name and the like. The mapper 14 may store this information and make it available to clients 12 performing queries. Thus, regardless of the type of communication between the server 16 and the client 12, information may be obtained by the client 12 from the mapper 14.

According to the embodiment of the invention shown in FIG. 4, a custom application on the client 12, which may be a mobile terminal, for example, may perform a Bluetooth inquiry in an effort to connect to discovered devices via IP or other networking. Thus, the client 12 may query for Bluetooth devices, read the query results, and begin communication with the one or more servers 16 using an IP based communication, for example.

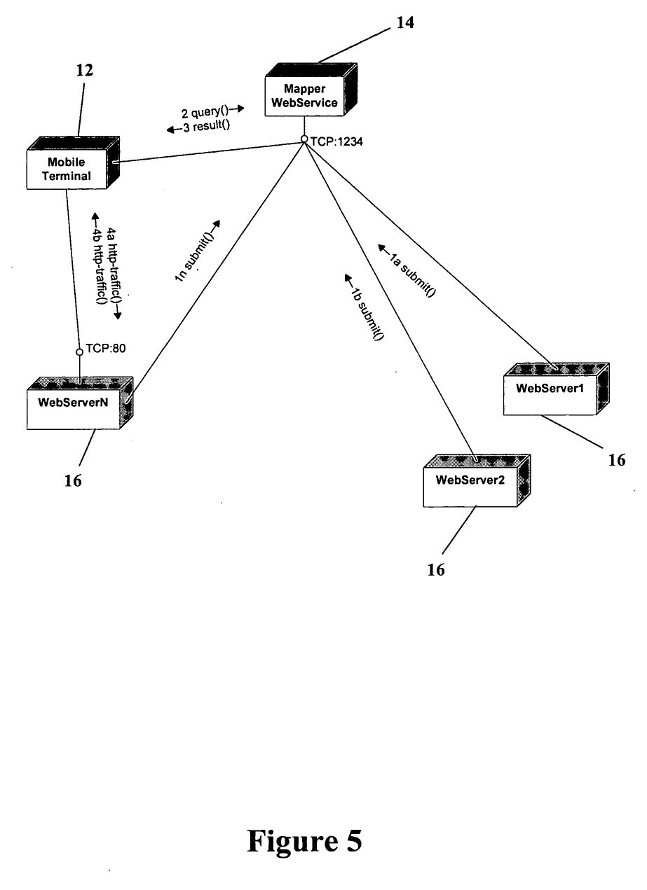

FIG. 5 shows a generalized block diagram for data transfer using a web server according to an embodiment of the present invention. In FIG. 5, one or more web servers 16 (mobile or stationary) may submit data of various types to a mapper 14. The data may be shared only once, such as at startup, for example, or may be shared regularly. Such data may include, without limitation, a BDA, a web server 16 url, a webserver 16 domain name, a cell i.d., BDAs of surrounding devices and the like. The mapper 14 may store this information and make it available to clients 12 performing queries. Thus, regardless of the type of communication between the web server 16 and the client 12, information may be obtained by the client 12 from the mapper 14.

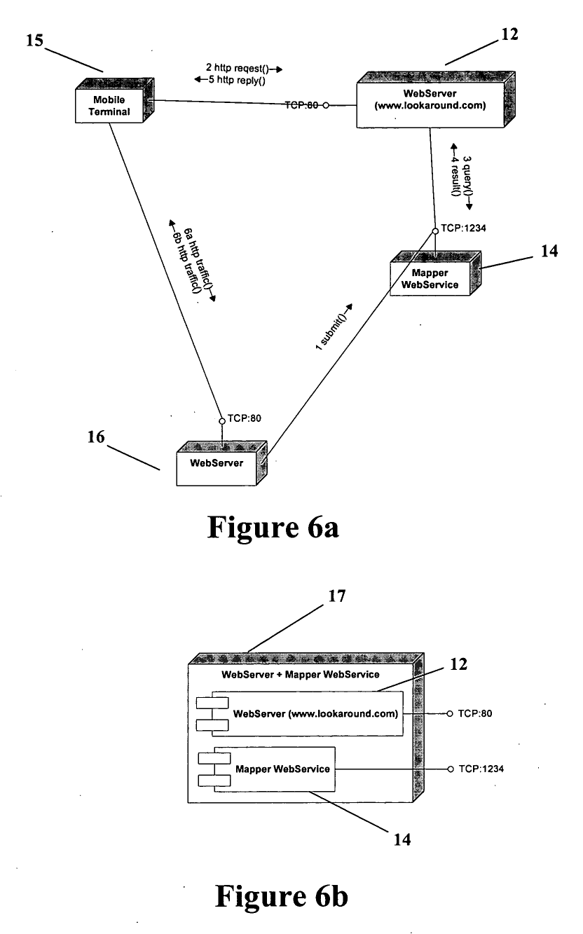

According to the embodiment of the invention shown in FIG. 5, a web browser on the client 12, which may be a mobile terminal, for example, may perform a Bluetooth inquiry in an effort to connect to discovered devices via HTTP messaging. Thus, the client 12 may query for Bluetooth devices, read the URL resulting from the query, and begin generating html pages and displaying them to a user. The user may then browse through data and pages at the URL. FIG. 6a shows another generalized block diagram for data transfer using a web server according to an embodiment of the present invention. The embodiment of the invention shown in FIG. 6a includes, without limitation, a client 12, a mapper 14, a server 16 and a mobile device 15. In FIG. 6a, a web server assumes the role of a client 12, in contrast to FIG. 5, where the client 12 was embodied in a mobile or other device. Thus, in FIG. 6a, html page generation is performed on the web server 12 rather than a mobile device. In the embodiment of the invention shown in FIG. 6a, the mobile device 15 performs conventional http traffic, such as, for example, asking for a page, receiving a page, displaying a page to a user, surfing by clicking on links, and the like.

As shown in FIG. 6a, the web server 12 may query for Bluetooth devices, read the URL resulting from the query, and begin generating html pages and sending them to the mobile device 15. Once a page is displayed to the user at the mobile device 15, the user may begin clicking on links and browsing to the web server 16 or other devices in its vicinity.

FIG. 6b shows a block diagram of an implementation of the embodiment of the invention shown in FIG. 6a. In FIG. 6b, the web server 12 and the mapper 14 are hosted on the same device 17. Although the web server 12 and the mapper 14 may be hosted on different devices, hosting the web server 12 and the mapper 14 on the same device 17 may reduce networking roundtrip time, cost, latency and the like.

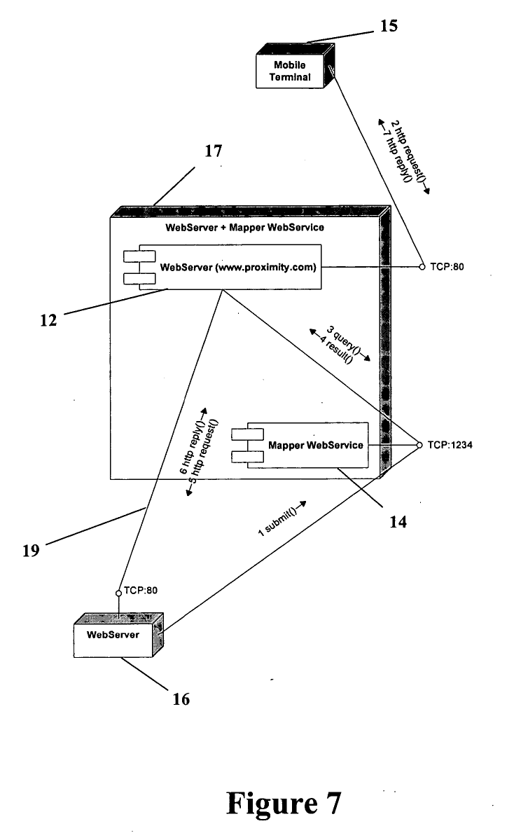

FIG. 7 shows another generalized block diagram for data transfer using a webserver according to an embodiment of the present invention. In FIG. 7, the web server 12 and the mapper 14 are hosted on the same device 17. In addition, the embodiment of the invention shown in FIG. 7 includes a connection 19 between the webserver 12 and the webserver 16. The web server 12 (identified as www.proximity.com) may function as a portal. Upon receiving a request, the web server 12 may forward the request and fetch a page, which it would send back to the mobile device 15 unmodified. Whereas, in FIG. 6a, a user was presented with a page holding a single link to the web server 16 in her vicinity, on which she could click to browse to a desired site, in FIG. 7 a user may simply type a URL, such as www.proximity.com/bda/112233445566 (assuming the BDA 11:22:33:44:55:66 corresponds to the webserver 16), for example, and be presented with a page for the web site, rather than being given an intermediate page where on which the user clicks.

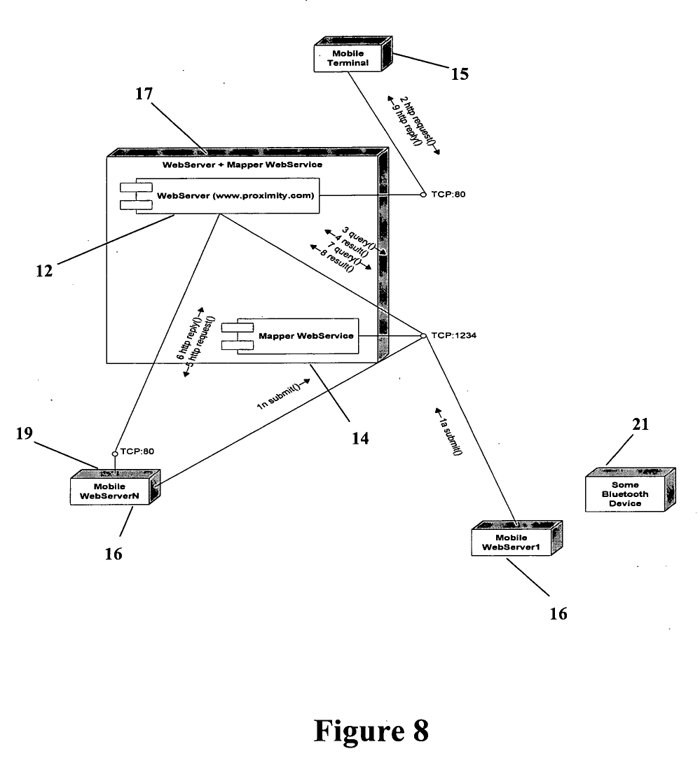

FIG. 8 shows generalized block diagram for data transfer according to another embodiment of the present invention. The embodiment of the invention shown in FIG. 8 includes, without limitation, a client 12, a mapper 14, one or more mobile web servers 16, a mobile device 15, a host device 17 and one or more Bluetooth devices 21. In FIG. 8, a mapper 14 is configured with publishers and associate addresses, such as IP address or domain names, for example. Also, two queries are performed in FIG. 8, one for mapping a publisher-name to IP address (messages 3, 4) and another for mapping a BDA to a publisher-name (messages 7, 8). In FIG. 8, the mobile device 15 may initiate a Bluetooth inquiry while the web server 12 actually makes the inquiry. Thus, in effect the mobile device 15 may query for Bluetooth devices that are effectively out of its Bluetooth range.

In the embodiment of the invention shown in FIG. 8, the web server 12 (identified in FIG. 8 as www.proximity.com) is a rewriting reverse proxy. Thus, messages may differ in a web browser before editing and after editing. In FIG. 8, if, for example, the URL www.proximity.com/publisher/˜johnny/proximity is typed into a browser application on the mobile device 15, indicating that the user is aware of a publisher called “johnny” and wishes to know who else is in his vicinity, the web server 12 will identify an IP address at which this publisher may be reached. Once reached, the web server 12 may post an HTTP request for the URL “/proximity.” If the device on which the publisher “johnny” resides is a mobile web server 16 capable of performing Bluetooth inquiries, the web server 16 may find one or more Bluetooth devices 21 having unique BDAs. The mobile web server 16 may then prepare html pages listing the BDAs and may include special comments that the rewriting reverse proxy (www.proximity.com) may obtain and edit. The rewriting reverse proxy may see the special comments and perform another query to map BDAs to publishers that are reachable. For example, if the mobile web server 16 finds to two Bluetooth devices 21, the rewriting reverse proxy may insert a link for the publisher for one of the devices and insert text saying that there is no publisher for the other device.

In FIG. 8, because the web server 12 is a reverse http proxy, other websites can be reached through it and may not even be aware of it. Thus, the web server 12 may include the feature of opening up the accessibility to mobile web servers 16 to the public by using their HTTP addresses. Thus, the web server 12 may perform queries for HTTP addresses (for example, messages 3, 4).

While particular embodiments of the present invention have been shown and described, it will be obvious to those skilled in the art that the invention is not limited to the particular embodiments shown and described and that changes and modifications may be made without departing from the spirit and scope of the appended claims.

What is claimed is:

1. A method for data transfer comprising:
performing a Bluetooth inquiry;
receiving an identifier token corresponding to a Bluetooth Device Address in response to the inquiry; and
initiating a data transfer using the identifier token.

2. The method of claim 1, wherein the identifier token is an IP address.

3. The method of claim 1, wherein the data transfer is an IP-based data transfer.

4. The method of claim 1, wherein the data transfer is a wireless data transfer.

5. The method of claim 1, wherein the data transfer is a wired data transfer.

6. The method of claim 1, wherein the data transfer is a peer-to-peer data transfer.

7. The method of claim 1, wherein the identifier token is a URL.

8. The method of claim 1, wherein the Bluetooth inquiry is performed by a server.

9. The method of claim 1, wherein the Bluetooth inquiry is performed by a client.

10. The method of claim 1, wherein the Bluetooth inquiry is performed by a mobile device.

11. The method of claim 1, wherein the data transfer is initiated by a server.

12. The method of claim 1, wherein the data transfer is initiated by a client.

13. The method of claim 3, wherein the IP-based transfer is an HTTP transfer.

14. A device for transferring data comprising:
a storage unit for storing data; and
a processor communicatively coupled to the storage unit, the processor configured to:
perform a Bluetooth inquiry;
receive an identifier token corresponding to a Bluetooth Device Address in response to the inquiry; and
initiate a data transfer using the identifier token.

15. The device of claim 14, wherein the identifier token is an IP address.

16. The device of claim 14, wherein the data transfer is an IP-based data transfer.

17. The device of claim 14, wherein the data transfer is a wireless data transfer.

18. The device of claim 14, wherein the data transfer is a wired data transfer.

19. The device of claim 14, wherein the data transfer is a peer-to-peer data transfer.

20. The device of claim 14, wherein the identifier token is a URL.

21. The device of claim 14, wherein the storage unit and the processor are disposed on a mobile device.

22. The device of claim 14, wherein the storage unit and the processor are disposed on a server.

23. The device of claim 22, wherein the server is a web server.

24. A system for data transfer comprising:
a client device for initiating a Bluetooth inquiry;
a first server for providing networking services, the first server configured to map a Bluetooth Device Address to an identifier token; and
a second server communicatively coupled to the client device and the first server, the second server configured to respond to a Bluetooth inquiry,
wherein the client device is configured to search for devices using Bluetooth and to transfer data to the devices using a networking protocol.

25. The system of claim 24, wherein the identifier token is an IP address.

26. The system of claim 24, wherein the networking protocol is an Internet protocol.

27. The system of claim 24, wherein the client device transfers data via a wireless connection.

28. The system of claim 24, wherein the client device transfers data via a wired connection.

29. The system of claim 24, wherein the client device transfers data via a peer-to-peer connection.

30. The system of claim 24, wherein the identifier token is a URL.

31. The system of claim 24, wherein the client device is a mobile device.

32. The system of claim 24, wherein the client device is a third server.

33. The system of claim 24, wherein the second server is a mobile device.

34. The system of claim 24, wherein the first server is a web server.

35. The system of claim 34, wherein the web server is the client device.

36. A computer program product comprising a computer useable medium having computer program logic recorded thereon for enabling a processor to transfer data, the computer program logic comprising:
a performing procedure enabling the processor to perform a Bluetooth inquiry;
a receiving procedure enabling the processor to receive an identifier token corresponding to a Bluetooth Device Address in response to the inquiry; and
an initiating procedure enabling the processor to initiate a data transfer using the identifier token.

37. The computer program product of claim 36, wherein the identifier token is an IP address.

38. The computer program product of claim 36, wherein the data transfer is an IP-based data transfer.

39. The computer program product of claim 36, wherein the data transfer is a wireless data transfer.

40. A device for data transfer comprising:
means for performing a Bluetooth inquiry;
means for receiving an identifier token corresponding to a Bluetooth Device Address in response to the inquiry; and
means for initiating a data transfer using the identifier token.

41. A method for data transfer comprising:
receiving an identifier token from a first device;
receiving a Bluetooth Device Address for the first device;
mapping the Bluetooth Device Address to the identifier token; and
transferring the identifier token to a second device subsequent to a Bluetooth inquiry by the second device.

42. The method of claim 41, wherein the identifier token is an IP address.

43. The method of claim 41, wherein the data transfer is an IP-based data transfer.

44. The method of claim 41, wherein the data transfer is a wireless data transfer.

45. The method of claim 41, wherein the data transfer is a wired data transfer.

46. The method of claim 41, wherein the data transfer is a peer-to-peer data transfer.

47. The method of claim 41, wherein the identifier token is a URL.

48. The method of claim 41, wherein the Bluetooth inquiry is performed by a server.

49. The method of claim 41, wherein the Bluetooth inquiry is performed by a client.

50. The method of claim 41, wherein the Bluetooth inquiry is performed by a mobile device.

51. The method of claim 41, wherein the data transfer is initiated by a server.

52. The method of claim 41, wherein the data transfer is initiated by a client.

53. The method of claim 43, wherein the IP-based transfer is an HTTP transfer.

54. The method of claim 41, further comprising initiating a data transfer using the identifier token.

55. The method of claim 54, wherein the data transfer is initiated by the second device.

56. A device for transferring data comprising:
a storage unit for storing data; and
a processor communicatively coupled to the storage unit, the processor configured to:
receive an identifier token from a first device;
receive a Bluetooth Device Address for the first device;
map the Bluetooth Device Address to the identifier token; and
transfer the identifier token to a second device subsequent to a Bluetooth inquiry by the second device.

57. A computer program product comprising a computer useable medium having computer program logic recorded thereon for enabling a processor to transfer data, the computer program logic comprising:
a first receiving procedure enabling the processor to receive an identifier token from a first device
a second receiving procedure enabling the processor to receive a Bluetooth Device Address for the first device;
a mapping procedure enabling the processor to map the Bluetooth Device Address to the identifier token; and
a transferring procedure enabling the processor to transfer the identifier token to a second device subsequent to a Bluetooth inquiry by the second device.
